(19) United States
(12) Patent Application Publication
(10) Pub. No.: US 2016/0380926 A1
(43) Pub. Date: Dec. 29, 2016

(54) Establishing Sender Identities in Synchronous and Asynchronous Communications

(71) Applicant: International Business Machines Corporation, Armonk, NY (US)

(72) Inventors: Judith H. Bank, Cary, NC (US); Liam Harpur, Dublin (IE); Ruthie D. Lyle, Durham, NC (US); Patrick J. O'Sullivan, Dublin (IE); Lin Sun, Morrisville, NC (US)

(21) Appl. No.: 14/752,962

(22) Filed: Jun. 28, 2015

(51) Int. Cl. H04L 12/58

(52) U.S. Cl. CPC H04L 51/02; H04L 51/12

(57) ABSTRACT

An approach is provided for establishing a sender identity. In the approach, a communication is received at a communication device over an electronic communications channel from a sender with the identity of the sender being withheld in the communication. An identification request is transmitted from the communication device to the sender over the electronic communications channel. Subsequently, a sender identification response is received at the communications device over the electronic communications channel. An acceptance criteria is applied to the received sender identification response. In response to a successful application of the acceptance criteria, the user of the communication device is notified of the communication.

### BACKGROUND OF THE INVENTION

Technical Field

This disclosure relates to utilizing telecommunications channels. More particularly, this disclosure relates to establishing sender identities where such identities are initially withheld.

Description of Related Art

Situations often arise where an individual receives a telephone call, a fax, a page, an email, or another type of electronic communication from another party. Furthermore, situations often arise where the identity of the originating party is withheld. An incoming call or fax may not have caller ID or may have caller ID information withheld. Likewise, individuals frequently receive emails where the originator is not present or such data is withheld, or from a server identity. Likewise, pages to an individual or SMS/text messages can withhold the identity.

Individuals receiving such messages or calls or electronic communications may wish to receive these communications, but only in instances where the identity of the sending party is known or trusted. Terminating all communications where the sender ID is not provided might result in legitimate communications not reaching the receiver. For example, if a family member attempts to telephone the user from a pay phone or from a foreign country, the caller ID data might not be transmitted because of the telephone being used by the family member. Automatic termination of such communications might result in the user not receiving an important message from a friend or family member.

### SUMMARY

An approach is provided for

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a processor and components of an information handling system;

FIG. 2 is a network environment that includes various types of information handling systems interconnected via a computer network;

FIG. 3 is a component diagram depicting an exemplary communications environment between a sender and a receiver;

FIG. 4 is a flowchart showing communications between the sender and the receiver; and

FIG. 5 is a flowchart showing exemplary steps taken by the receiver to manage communications received from unknown senders.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

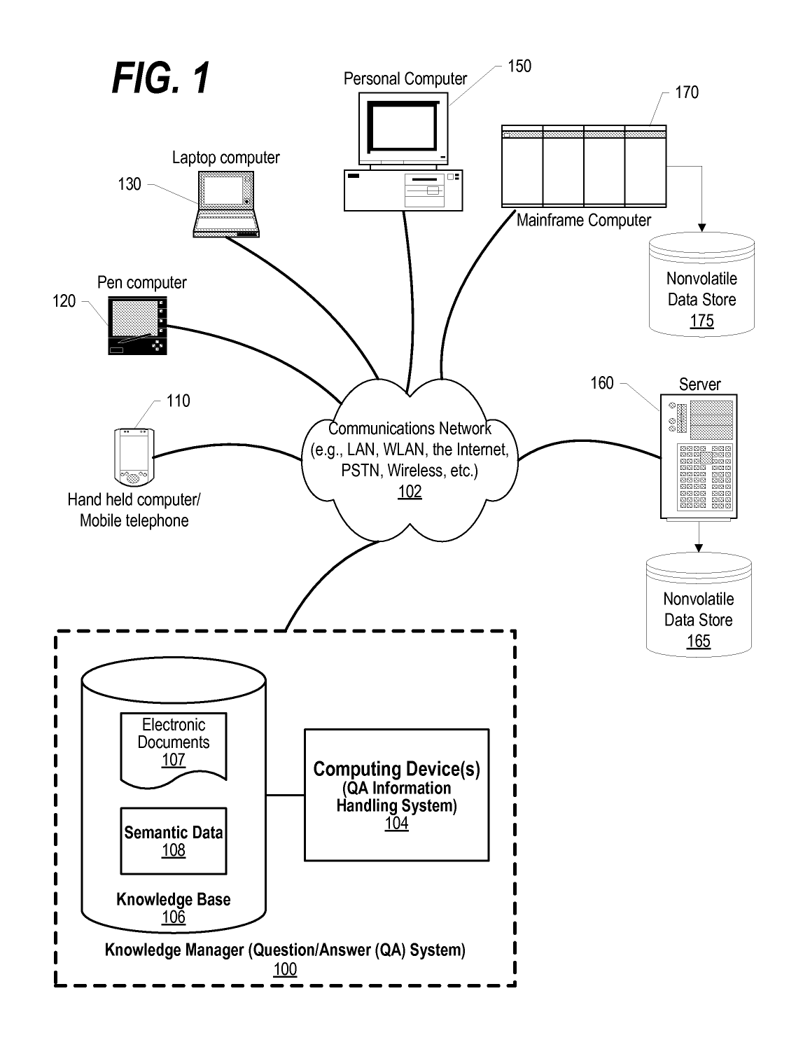

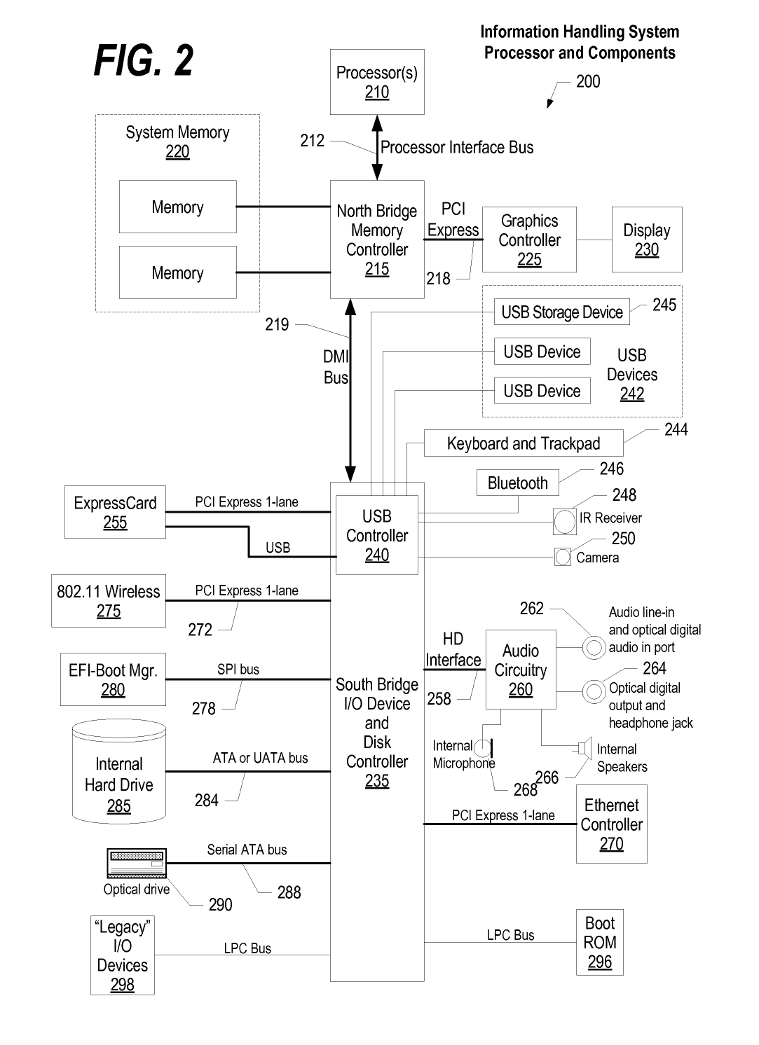

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

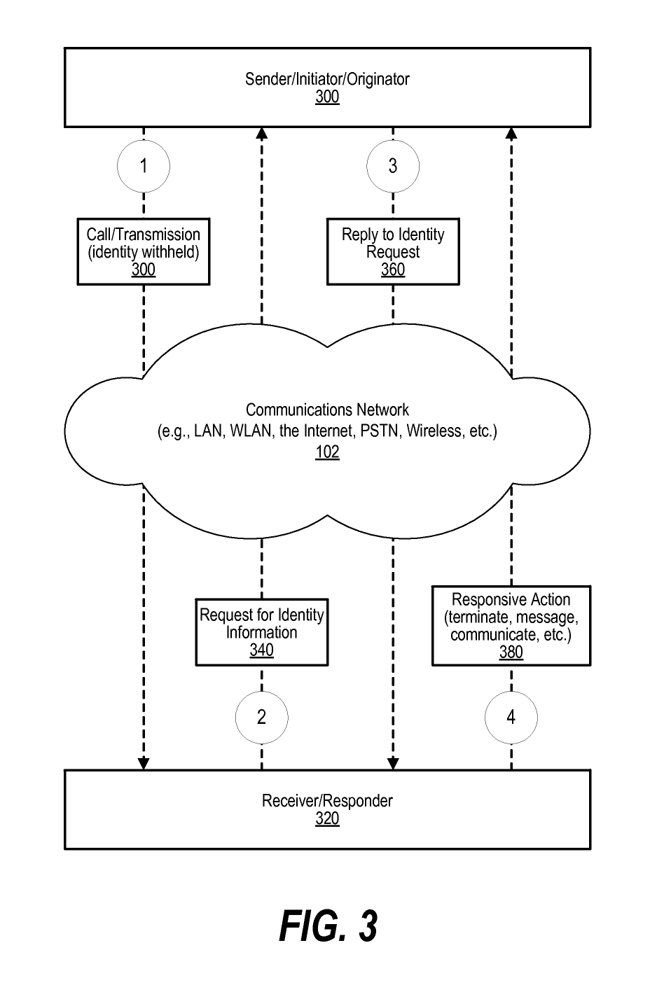

FIGS. 3-5 show an approach for selecting a telecommunications channel. As used herein, “telecommunications,” includes any digital communications transmitted either via a wired system, a wireless system, or a system utilizing both wired and wireless components. Individuals receiving messages or calls or electronic communications may wish to receive these communications, but only in instances where the identity of the sending party is known or trusted. Examples include PSTN calls, IP calls, Pages, Faxes, Notifications, Pagers, SMS etc. Conventional art protects users by restricting communications—e.g. do not allow my phone to ring if caller ID is not present, treat email as SMAP if there is no originating identity, only allow pages or SMSs or Calls or communications from a pre-set group of users. Situations may arise where the communication may be legitimate, but the incoming communication is blocked owed to satisfying the latter rules. Likewise, the sender may also be legitimate, and may not be aware that configuration on their side is limiting the ability of a successful communication.

The approach described herein triggers a business process workflow on behalf of the receiving user. This business process workflow can be motivated by a server or device preference specified by the user (e.g. account settings for a PSTN line, cell settings/preferences for a GSM phone, etc). It can also be triggered by an operator or administrator, or via admin support triggered by the user. The approach triggers a handshaking protocol between the receiving device and the sending device. The handshaking protocol has two primary steps. First, the receiving device acknowledges that the incoming call/communication has no identity, or is anonymous, or is unknown. User settings are interrogated to ascertain how the user wishes to handle the communication. If the preference is for the user to simply not receive calls (or messages) then the call will not come through. However, this approach provides a way to establish a sender's identity by taking steps to establish this identity. In the second step of the approach, handshaking occurs between the devices with the originating device requesting that the sender provide identity information. The incoming call is left open whilst this takes place. On the originating device a message is provided asking the sender to provide identity information. For example, the prompt might be “the recipient of this communication has requested your identity, dialed number will not accept call without identity, do you wish to reveal your identity?” If the originator (sender) rejects the request, then the call is terminated on the receiver's side. However, if the originator accepts and provides identity information, then the session information for the call in progress is updated with the user's identity—which may be caller ID in the case of a phone call.

Likewise, in one embodiment, the business workflow may operate on the user's behalf to establish precision in the identity. For example, the workflow may provides prompts, such as a pop-up dialog, on the sending device that forces the sender to provide particular identification details before allowing the call to interrupt the receiver. Indeed, in a world of rich devices, such as “smart phones,” such a workflow can also mandate a field to be filled describing “brief purpose of call/communication”. In a PSTN example the receiving user can then see the additional data and chose whether to answer the call or not.

Likewise, in one embodiment the workflow that mandates field(s) to be completed to describe the “brief purpose of call/communication,” etc. can also relay a message back to the sender. For example, a PSTN user receiving a call with this message can chose a “respond with message” option whereby the call is suspended in favor of a message that is sent from the receiver back to the sender perhaps allowing for constraints like “John—mad busy now, can you call me back at 6 pm, I am free then” or “John—I have no update on the PwC project, I'll know more at noon and will call you when I have this”. Hence a PSTN interruption in this way is converted in to a two-way instant messaging communication leveraging native SMS on both receiving and sending devices.

FIG. 3 is a component diagram depicting an exemplary communications environment between a sender and a receiver. In the first step (1), sender 300, also referred to as the “initiator” of the communication and the “originator” of the communication, initiates communication with receiver 320 (also referred to as the “responder” of the communication) by sending call or transmission 310 in which the identity of the sender is withheld. The withholding of the sender's identity might be on purpose, might be accidental, or might be because of the technology or infrastructure being utilized by the sender. Communications are transmitted via communications network 200 such as the Internet, the public-switched-telephone-network (PSTN), wireless communication, or any electronics communication channel.

In the second step (2), receiver 320 receives the transmission on the user's communication device and automatically requests identity information from the sender by sending an identification request to sender 300 over electronic communications channel 200 using transmission 340. Transmission 340 is sent automatically from the user's communication device without interrupting the user of the communication device. In the third step (3), sender 300 replies to the identification request with the requested information (e.g., name, phone number, etc.) by transmitting sender identification response transmission 360 to the receiver over electronic communications channel 200. Based upon the sender identification data received at the user's communication device, a responsive action is performed at 380. The responsive action might be to terminate the communication if the sender was found to be someone with whom the receiver did not wish to communicate, such as a political message or solicitation message. The responsive action might be to transmit a message back to the sender and terminate the communication session (e.g., “sorry, I can't talk now, I'll call you later”).

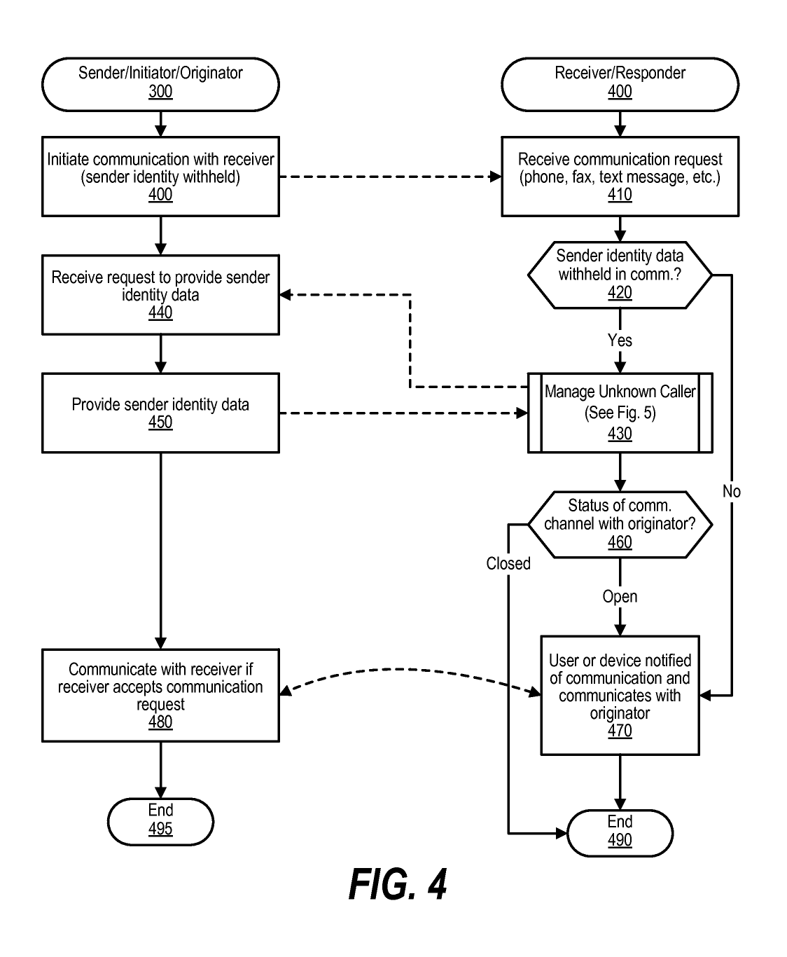

FIG. 4 is a flowchart showing communications between the sender and the receiver. FIG. 3 processing commences at 300 and the left side of the flowchart shows the steps taken by the sender (i.e., initiator, originator, etc.) of the communication. At step 400, the process initiates communication with receiver with the sender's identity data being withheld from the communication (e.g., caller ID data withheld, etc.).

The right side of the flowchart commences at 320 and shows the steps taken by the receiver (i.e., responder, etc.) of the communication. At step 410, the process performed by the receiver's communication device receives the communication request (e.g., phone call, fax, text message, etc.). The process performed on the receiver's communication device determines as to whether the sender's identity data was withheld from the communication (decision 420). If the sender's identity data was withheld from the communication, then decision 420 branches to the ‘yes’ branch to perform predefined process 430. On the other hand, if the sender's identity data was included in the communication, then decision 420 branches to the ‘no’ branch bypassing predefined process 430.

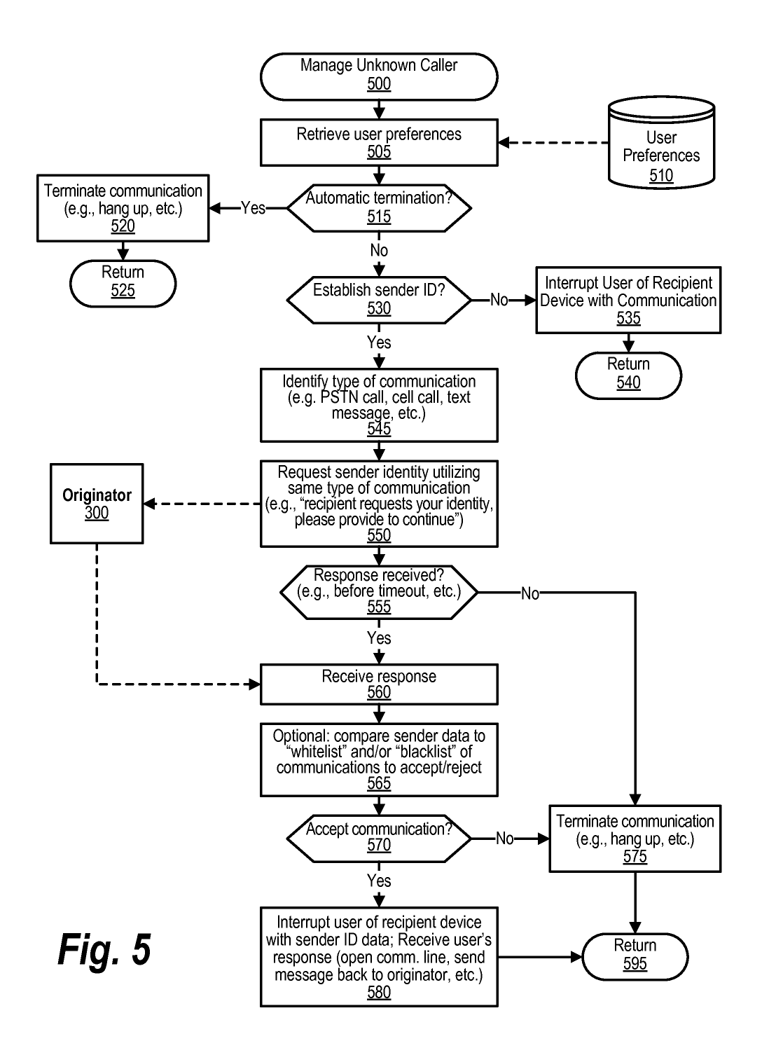

If the sender's identity data was withheld from the communication then, at predefined process 430, the process performs the Manage Unknown Caller routine (see FIG. 5 and corresponding text for processing details). At step 440, the sender's device receives a request to provide the sender's identity data to the receiver. If the sender desires to open the communication channel with the receiver, then at step 450, the sender provides the requested sender identity data and this data is transmitted to the receiver.

The result of predefined process 430 will either be an open communication channel with the sender or having the channel closed (terminated). The process running on the receiver's device determines as to whether the status of communication with the sender is open or closed (decision 460). If communications are open, then decision 460 branches to the “open” branch and, at step 470, the process notifies the user of the device of the communication and the user is able to communicate with the sender. On the other hand, if the result of predefined process 430 is a closed communication channel, then decision 460 branches to the “closed” branch bypassing step 470. Receiver processing thereafter ends at 490. Returning to sender processing, at step 480, the sender communicates with receiver if the receiver accepted the sender's communication request after receiving the sender's identification information. Sender processing thereafter ends at 495.

FIG. 5 is a flowchart showing exemplary steps taken by the receiver to manage communications received from unknown senders. FIG. 5 processing commences at 500 and shows the steps taken by a process that manages unknown callers (unknown senders). At step 505, the process retrieves user preferences from user preferences data store 510. The process determines as to whether the user preferences indicate an automatic termination of communications where the sender's identification data is withheld (decision 515).

If the user preferences indicate an automatic termination of communications where the sender's identification data is withheld, then decision 515 branches to the ‘yes’ branch whereupon, at step 520, the process terminates the communication with the sender (e.g., hang up, etc.) and processing returns to the calling routine at 525. On the other hand, if the user preferences do not indicate an automatic termination of communications where the sender's identification data is withheld, then decision 515 branches to the ‘no’ branch and processing continues.

The process next determines as to whether the user preferences indicate a preference to establish the sender's identification (decision 530). If the user preferences do not indicate a preference to establish the sender's identification, then decision 530 branches to ‘no’ branch whereupon, at step 535, the process interrupts the user of the recipient device with the communication and processing returns to the calling routine at 540. On the other hand, if the user preferences indicate a preference to establish the sender's identification then decision 530 branches to the ‘no’ branch and processing continues to establish the sender's identity.

At step 545, the process identifies the type of communication being conducted (e.g. PSTN call, cell call, text message, etc.). At step 550, the process transmits an identification request to the sender over the electronic communications channel. For example, the identification request might state “recipient requests your identity, please provide to continue.” The identification request is transmitted to originator (sender) 300. The process running on the receiver's communication device determines as to whether a sender identification response was received from the sender (decision 555).

If a sender identification response was received from the sender, then decision 555 branches to the ‘yes’ branch for further processing. On the other hand, if a sender identification response was not received from the sender, then decision 555 branches to the ‘no’ branch whereupon the communication is terminated at 575 and processing returns to the calling routine at 595. At step 560, the process receives the sender identification response from the sender.

At step 565, the process applies an acceptance criteria to the received sender identification response, with the user of the communication device being notified in response to a successful application of the acceptance criteria. In one embodiment, the acceptance criteria compares the received sender identification data to a “whitelist” and/or “blacklist” of communications to accept and/or reject.

The process determines as to whether to accept communications with the sender (decision 570). If communications with the sender is accepted, then decision 570 branches to the ‘yes’ branch whereupon at step 580, the process interrupts the user of the recipient device with the sender's identification data, and a user response is received (open comm. line, send message back to originator, etc.). in one embodiment, the response can be a terminating message (e.g., “sorry, I'm really busy but will call you back in a while,” etc.). On the other hand, if communications with the sender is not accepted, then decision 570 branches to the ‘no’ branch whereupon the communication is terminated at 575 and processing returns to the calling routine at 595.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising one or more processors and a memory of establishing a sender identity, the method comprising:
receiving, over an electronic communications channel, a communication from a sender wherein an identity of the sender is withheld, wherein the communication is received at a communication device;
transmitting an identification request to the sender over the electronic communications channel;
receiving, over the electronic communications channel, a subsequent sender identification response from the sender; and
applying an acceptance criteria to the received sender identification response, wherein a user of the communication device is notified in response to a successful application of the acceptance criteria.

2. The method of claim 1 further comprising:
receiving a reply from the user of the communication device, wherein the reply is a response to the sender identification response;
transmitting the reply from the communication device to the sender over the electronic communications channel; and
terminating the electronic communications channel after transmission of the reply.

3. The method of claim 1 wherein the applying of the acceptance criteria further comprises:
comparing the received sender identification response to a list of previously established identifications, wherein the successful application is based on the comparison.

4. The method of claim 1 further comprising:
in response to an unsuccessful application of the acceptance criteria:
inhibiting communication by the sender to the communication device, wherein the inhibiting further inhibits disturbing the user of the communication device.

5. The method of claim 1 wherein the communication is selected from a group consisting of a telephone call, a facsimile, a short message service (SMS) message, an instant message (IM), a text message, and an electronic communication.

6. The method of claim 1 wherein the received sender identification response includes one or more fields selected from the group consisting of a sender name, a sender phone number, a sender identification number, a sender identity description, a purpose of the communication, and a message.

7. The method of claim 6 further comprising:
retrieving the one or more fields from a user configuration data store accessible from the communication device, wherein the retrieved fields are included in the identification request.

8. An information handling system comprising:
one or more processors;
a memory coupled to at least one of the processors;
a telecommunications adapter, accessible by at least one of the processors; and
a set of instructions stored in the memory and executed by at least one of the processors to establish a sender identity, wherein the set of instructions perform actions of:
receiving, over an electronic communications channel, a communication from a sender wherein an identity of the sender is withheld, wherein the communication is received at a communication device;
transmitting an identification request to the sender over the electronic communications channel;
receiving, over the electronic communications channel, a subsequent sender identification response from the sender; and
applying an acceptance criteria to the received sender identification response, wherein a user of the communication device is notified in response to a successful application of the acceptance criteria.

9. The information handling system of claim 8 wherein the actions further comprise:
receiving a reply from the user of the communication device, wherein the reply is a response to the sender identification response;
transmitting the reply from the communication device to the sender over the electronic communications channel; and
terminating the electronic communications channel after transmission of the reply.

10. The information handling system of claim 8 wherein the applying of the acceptance criteria further comprises:
comparing the received sender identification response to a list of previously established identifications, wherein the successful application is based on the comparison.

11. The information handling system of claim 8 wherein the actions further comprise:
in response to an unsuccessful application of the acceptance criteria:
inhibiting communication by the sender to the communication device, wherein the inhibiting further inhibits disturbing the user of the communication device.

12. The information handling system of claim 8 wherein the communication is selected from a group consisting of a telephone call, a facsimile, a short message service (SMS) message, an instant message (IM), a text message, and an electronic communication.

13. The information handling system of claim 8 wherein the received sender identification response includes one or more fields selected from the group consisting of a sender name, a sender phone number, a sender identification number, a sender identity description, a purpose of the communication, and a message.

14. The information handling system of claim 13 wherein the actions further comprise:
retrieving the one or more fields from a user configuration data store accessible from the communication device, wherein the retrieved fields are included in the identification request.

15. A computer program product stored in a computer readable storage medium, comprising computer instructions that, when executed by an information handling system, causes the information handling system to establish a sender identity by performing actions comprising:
receiving, over an electronic communications channel, a communication from a sender wherein an identity of the sender is withheld, wherein the communication is received at a communication device;
transmitting an identification request to the sender over the electronic communications channel;
receiving, over the electronic communications channel, a subsequent sender identification response from the sender; and
applying an acceptance criteria to the received sender identification response, wherein a user of the communication device is notified in response to a successful application of the acceptance criteria.

16. The computer program product of claim 15 wherein the actions further comprise:
receiving a reply from the user of the communication device, wherein the reply is a response to the sender identification response;
transmitting the reply from the communication device to the sender over the electronic communications channel; and
terminating the electronic communications channel after transmission of the reply.

17. The computer program product of claim 15 wherein the applying of the acceptance criteria further comprises:
comparing the received sender identification response to a list of previously established identifications, wherein the successful application is based on the comparison.

18. The computer program product of claim 15 wherein the actions further comprise:
in response to an unsuccessful application of the acceptance criteria:
inhibiting communication by the sender to the communication device, wherein the inhibiting further inhibits disturbing the user of the communication device.

19. The computer program product of claim 15 wherein the communication is selected from a group consisting of a telephone call, a facsimile, a short message service (SMS) message, an instant message (IM), a text message, and an electronic communication.

20. The computer program product of claim 15 wherein the received sender identification response includes one or more fields selected from the group consisting of a sender name, a sender phone number, a sender identification number, a sender identity description, a purpose of the communication, and a message, and wherein the actions further comprise:
retrieving the one or more fields from a user configuration data store accessible from the communication device, wherein the retrieved fields are included in the identification request.
